(19) United States
(12) Patent Application Publication
(10) Pub. No.: US 2017/0113561 A1
(43) Pub. Date: Apr. 27, 2017

(54) ENERGY CHARGING SYSTEM RELATED TO THE STOP OF AN ELECTRIC VEHICLE

(71) Applicant: Sequoia Automation S.r.l., San Mauro Torinese (IT)

(72) Inventor: Massimo IPPOLITO, San Mauro Torinese (IT)

(73) Assignee: Sequoia Automation S.r.I., San Mauro Torinese (IT)

(21) Appl. No.: 15/129,318

(22) PCT Filed: Feb. 2, 2015
(86) PCT No.: PCT/IT2015/000016

§ 371 Date: Sep. 26, 2016

(30) Foreign Application Priority Data
Mar. 26, 2014 (IT) T02014A000252

(51) Int. Cl. B60L 11/18; B60L 8/00

(52) U.S. Cl. CPC B60L 11/1812; B60L 8/006; B60L 11/1816; B60L 2200/26; B60L 2230/24; B60L 2230/32

(57) ABSTRACT

An energy charging system (1) is described, comprising at least one operator vehicle (10) equipped with at least one electrically supplied traction engine and moving along at least one operating path (R10), and at least one backup vehicle (20) equipped with at least one device (30) adapted to produce, accumulate and transfer electric energy to such operator vehicle (10) through a connection directly and automatically performed next to at least one stop (S1, S2, . . . Sn) of such operator vehicle (10) along at least one said operating path (R10) for recharging one or more electric supply batteries of the traction engine, such backup vehicle (20) being adapted to move on a path spatially and timely related to such stop (S1, S2, . . . Sn) of the operator vehicle (10).

The present invention refers to an energy charging (“biberonaggio”) system related to the stop of an electric vehicle.

As known, the term “biberonaggio” means the partial recharge of batteries with which standalone electric locomotion means are equipped.

Typically, this term designates the recharge operation which is performed during the prolonged stays of these means in suitably equipped areas.

Such system drastically reduces the need of an electro-chemical accumulation of electric energy on board the means, demanding to the territory the function of providing the necessary energy to the means, thereby removing the autonomy problem.

In particular, IT2006TO00610 of the same Applicant discloses an energy charging system with quick recharge of a means of transport with electric traction, performed at every foreseen stop of the vehicle by means of a connection which can be directly and automatically performed next to the stop itself, through the road bed, comprising an insulating mat which houses plane metal contacts organized in an array, laid on the road bed adjacent to the stop, an outlet counter-array placed on the bottom in the vehicle flatbed, equipped with spring-type contacts and equipped with positioning systems, a battery of super-capacitors on board the vehicle, suitably connected in order to reach voltages and currents which are compatible with the switching devices of the conversion and control electronics, and a battery of super-capacitors housed in the ground next to the mat, connected in order to reach voltages and currents compatible with the switching devices of the conversion and control electronics.

The stops foreseen along the vehicle path are equipped with the mat, the battery of super-capacitors and with electro-chemical accumulation capabilities.

The stops foreseen along the vehicle path are connected to the electric mains and/or equipped with a photovoltaic panel capable of producing energy to be accumulated and to be transferred to the vehicle.

Such system, however, does not solve the problem of having to perform the recharge only in the pre-established supply stations for such means of transport with electric traction.

Moreover, IT2007TO00233 of the same Applicant, discloses a wind system for energy conversion comprising a power wing profile driven from ground immersed in a wind current, a module adapted to translate on a rail placed next to the ground and connected through a tether to such power wing profile driven by such module dragged on such rail and perform the conversion from wind energy into electric energy through a generating system cooperating with the module and the rail, the tether adapted to transmit mechanical energy to and from the wing profile, and control a flight trajectory of the wing profile. Such module is equipped with a trolley for translating along such rail and adapted to perform a recovery of such tether and to allow an energy conversion.

Such system, however, does not solve the problem of not being able to transfer electric energy to an external vehicle from any point placed along such rail.

Object of the present invention is solving the above prior art problems by providing an energy charging system of an operator vehicle with electric traction capable of transferring electric energy and of performing the recharge next to any point of a definite path.

The above and other objects and advantages of the invention, as will appear from the following description, are obtained with an energy charging system of a means of transport with electric traction as claimed in claim 1. Preferred embodiments and non-trivial variations of the present invention are the subject matter of the dependent claims.

It is intended that the enclosed claims are an integral part of the present description.

It will be immediately obvious that numerous variations and modifications can be made to the described apparatus and method (for example related to shape, sizes, arrangements, various colors and parts with equivalent functionality) without departing from the scope of the invention as appears from the enclosed claims.

The present invention will be better described by some preferred embodiments, provided as a non-limiting example, with reference to the enclosed drawings, in which:

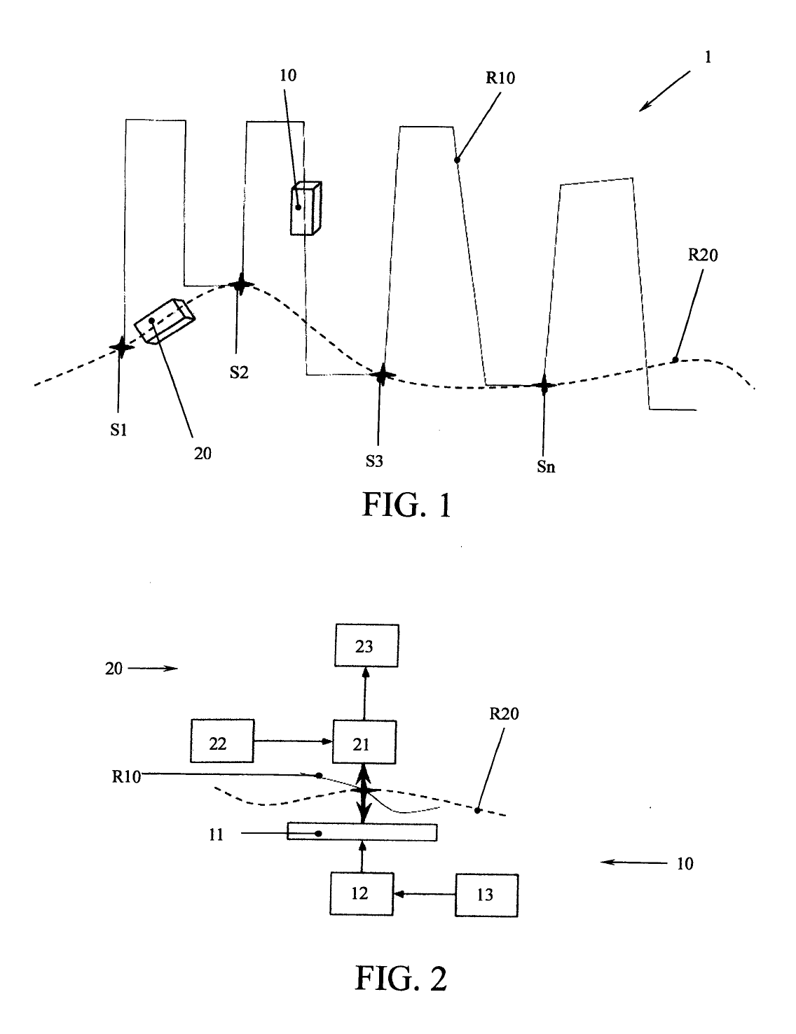

FIG. 1 shows a general diagram of a preferred embodiment of the energy charging system according to the present invention;

FIG. 2 shows a diagram of a preferred embodiment of a connection which can be directly and automatically performed through the charging system according to the present invention; and

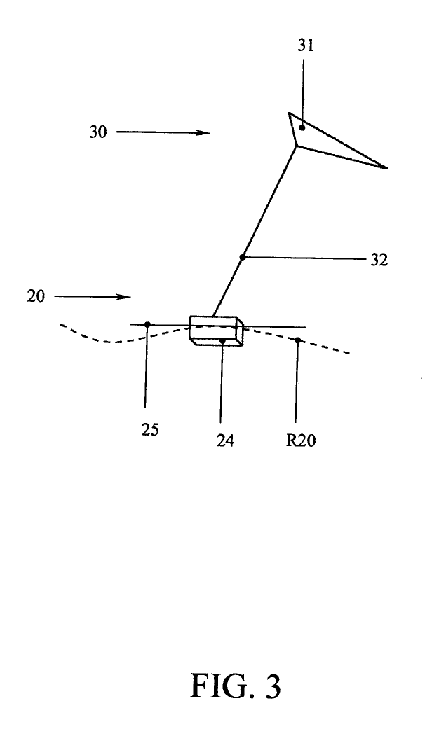

FIG. 3 shows a diagram of an embodiment of a device adapted to produce, accumulate and transfer energy through the charging system according to the present invention.

With reference to FIG. 1, it is possible to nota that the energy charging system 1 according to the present invention comprises at least one operator vehicle 10, equipped with at least one electrically supplied traction engine and moving along at least one operating path R10, and at least one backup vehicle 20 equipped with at least one device 30 adapted to produce, accumulate and transfer electric energy al operator vehicle 10 through a connection directly and automatically performed next to at least one stop S1, S2, . . . Sn of such operator vehicle 10 along the operating path R10 for recharging one or more electric supply batteries of its own traction engine, the backup vehicle 20 being adapted to move along a path which is spatially and timely related to the stop S1, S2, . . . Sn of the operator vehicle 10 itself.

With reference to FIG. 2, it is possible to note that, for performing the above connection, the operator vehicle 10 is equipped with at least one outlet counter-array placed on the flatbed comprising spring-type metallic contacts 11 and suitable positioning systems. A battery or super-capacitors 12 allows reaching voltages and currents compatible with the switching devices of conversion and control electronics 13.

In the same way, such backup vehicle 20 is equipped with an insulating mat which houses plane metallic contacts 21 organized in an array. A battery of super-capacitors compatible with the switching devices of conversion and control electronic 23.

The connection between the insulating mat belonging to the backup vehicle 20 and the outlet counter-array belonging to the operator vehicle 10 automatically occurs during the provided stays of the operator vehicle 10 through a casual overlapping which cannot be identified. A double diagnostics system in real time allows verifying spring-type and plane contacts arranged in an array of said metallic contacts 11, 21.

With reference to FIG. 3, it is possible to note that the backup vehicle 20 is preferably of the type moving comprising at least one module 24 adapted to translate on a rail 25 placed next to the ground allowing such vehicle 20 to move along its own path R20 connected to the series of such stops S1, S2, . . . Sn, of the operator vehicle 10.

As shown, the device 30 adapted to produce, accumulate and transfer energy is supported by the backup vehicle 20.

In this case, the device 30 can be composed of at least one wind system for energy conversion through a power wing profile 31 driven from ground and immersed in at least one wind current.

Such module 24 is connected through at least one tether 32 to such power wing profile 31 driven by the module 24, such tether 32 adapted to transmit mechanical energy from and to such wind profile 31 and control a flight trajectory.

Such module 24 comprises means for driving such wing profile 31, means for storing the tether 32, and means for performing the energy conversion.

As can be noted from the previous description, the present invention refers to an energy recharge service from at least one operator vehicle, such as an agricultural tractor of the electric type, by means of a backup vehicle which accumulates the generated energy, by moving on a path correlated to each of such stops, taking care of transferring the energy addressee towards with such operating machine.

At the end of every working step, the operator vehicle can, by recharging its own batteries, find again, next to different stops, such backup vehicle adapted to take care of the energy recharge by means of a connection which can be directly and automatically performed.

1. Energy charging system (1) comprising at least one operator vehicle (10) equipped with at least one electrically supplied traction engine and moving along at least one operating path (R10), and at least one backup vehicle (20) equipped with at least one device (30) adapted to produce, accumulate and transfer electric energy to said operator vehicle (10) through a connection performed directly and automatically next to a plurality di stops (S1, S2, . . . Sn) of said operator vehicle (10) along at least one said operating path (R10) for recharging one or more electric supply batteries of said traction engine, said backup vehicle (20) being adapted to move on a path, spatially and timely correlated with the stop (S1, S2, . . . Sn) of said operator vehicle (10), characterized in that said backup vehicle (20) is of the moving type, said backup vehicle (20) comprising at least one module (24) adapted to translate on at least one rail (25) placed next to the ground allowing said backup vehicle (20) of moving said path related to said stop (S1, S2, . . . Sn) of said operator vehicle (10), said device (30) being composed of at least one wind system for the energy conversion through at least one power wing profile (31) driven from the ground and immersed in at least one wind current, said module (24) being connected through at least one tether (32) to said power wing profile (31) driven by said module (24), said tether (32) being adapted to transmit mechanical energy from and to said wing profile (31) and control a flight trajectory of said wing profile (31).

2. Energy charging system (1) according to the previous claim, characterized in that said vehicle (10, 20) is equipped with metallic contacts (11, 21) adapted to perform said connection, next to said stop (S1, S2, . . . Sn), and at least one battery of super-capacitors (12, 22) adapted to reach voltages and currents compatible with the switching devices of the conversion and control (13, 23).

3. Energy charging system (1) according to the previous claim, characterized in that it comprises a double diagnostic system in real time operating in parallel adapted to verify spring-type contacts and contacts of the plane type, arranged in an array of said metal contacts (11, 21).

4. Energy charging system (1) according to claim 1, characterized in that said module (24) comprises means for driving said wind profile (31), means for storing said tether (32), means for performing said energy conversion.
